(19) United States
(12) Patent Application Publication
(10) Pub. No.: US 2024/0091703 A1
(43) Pub. Date: Mar. 21, 2024

(54) METHOD AND APPARATUS FOR LOW TEMPERATURE REGENERATION OF ACID GAS USING A CATALYST

(71) Applicant: Saudi Arabian Oil Company, Dhahran (SA)

(72) Inventor: Guillaume Robert Jean-Francois Raynel, Dhahran (SA)

(21) Appl. No.: 17/933,727

(22) Filed: Sep. 20, 2022

(51) Int. Cl. B01D 53/86; B01D 53/78; B01D 53/96; B01J 23/02; B01J 27/232

(52) U.S. Cl. CPC B01D 53/8618; B01D 53/78; B01D 53/8671; B01D 53/96; B01J 23/02; B01J 27/232; B01D 2255/2047; B01D 2257/504

(57) ABSTRACT

A method for regenerating carbon dioxide and hydrogen sulfide from acid gas using a catalyst containing a group 2 element is provided. The method reduces the energy required for the regeneration process and allows for an efficient and cost-effective way to regenerate acid gas.

### TECHNICAL FIELD

This document relates to methods for regenerating carbon dioxide (CO₂) and hydrogen sulfide (H₂S) from acid gas using a catalyst. This document also relates to efficient and cost-effective methods of regenerating CO₂ and H₂S from aqueous absorbent solutions.

### BACKGROUND

The capture of carbon dioxide (CO₂) and hydrogen sulfide (H₂S) from acid gas is an important focus in the oil and gas industry, in part because of concerns and policies relating to climate change. CO₂ and H₂S capture from natural gas typically involves the amine process or the use of potassium carbonate and requires high amounts of energy. This is primarily due to the high temperature of regeneration, the temperature threshold at which acid gases are released from the aqueous sorbent solution of the acid gas-rich absorbent, and steam stripping. Methods involving amines having regeneration temperatures as low as about 120° C. (393K) have been developed, though these methods still require high amounts of energy.

Therefore, there is a need for a method that enables efficient and cost-effective regeneration of CO₂ and H₂S from acid gas. There is also a need for a method for reducing the energy required for the regeneration process of an acid gas absorbent.

### SUMMARY

Provided in the present disclosure a method for removing carbon dioxide (CO₂) from an air or gas stream, the method including contacting the air or gas stream containing CO₂ with an aqueous composition containing an aqueous carbonate (or amine) solution and a regeneration catalyst under conditions to form an aqueous bicarbonate composition; heating the aqueous bicarbonate composition to about 45° C. to less than about 100° C. to free a gaseous stream containing CO₂ from the aqueous bicarbonate composition, resulting in an aqueous carbonate composition; and collecting the gaseous stream containing CO₂; where the regeneration catalyst contains an element from group 2 of the periodic table.

In some embodiments of the method, the regeneration catalyst contains magnesium or calcium. In some embodiments, the regeneration catalyst is magnesium carbonate. In some embodiments, the concentration of the regeneration catalyst in the aqueous composition is about 0.01 mg/L to about 400 mg/L.

In some embodiments of the method, the heat source is a recovered or renewable heat source. In some embodiments, the heat source is selected from low-pressure steam recovered from another process, hot water recovered from another process, or the sun.

In some embodiments, the method further includes recycling the aqueous carbonate composition subsequent to freeing the gaseous stream containing CO₂ from the aqueous bicarbonate composition.

In some embodiments, the method further includes cooling the aqueous carbonate composition prior to recycling the aqueous carbonate composition and subsequent to freeing the gaseous stream containing CO₂ from the aqueous bicarbonate composition. In some embodiments, the cooling source is ambient air or the sea or ocean.

In some embodiments of the method, the air or gas stream is acid gas.

Also provided in the present disclosure is a method for removing hydrogen sulfide (H₂S) from a gas stream, the method including contacting the gas stream containing H₂S with an aqueous composition containing an aqueous carbonate (or amine) solution and a regeneration catalyst under conditions to form an aqueous hydrosulfide composition; heating the aqueous hydrosulfide composition to about 60° C. to less than about 100° C. to free a gaseous stream containing H₂S from the aqueous hydrosulfide composition, resulting in an aqueous hydroxide composition; and collecting the gaseous stream comprising H₂S; where the regeneration catalyst contains an element from group 2 of the periodic table.

In some embodiments of the method, the regeneration catalyst contains magnesium or calcium. In some embodiments, the regeneration catalyst is magnesium hydroxide. In some embodiments, the concentration of the regeneration catalyst in the aqueous composition is about 0.01 mg/L to about 400 mg/L.

In some embodiments of the method, the heat source is a recovered or renewable heat source. In some embodiments, the heat source is selected from low-pressure steam recovered from another process, hot water recovered from another process, or the sun.

In some embodiments, the method further includes recycling the aqueous hydroxide composition subsequent to freeing the gaseous stream containing H₂S from the aqueous hydrosulfide composition.

In some embodiments, the method further includes cooling the aqueous hydroxide composition prior to recycling the aqueous hydroxide composition and subsequent to freeing the gaseous stream containing H₂S from the aqueous hydrosulfide composition. In some embodiments, the cooling source is ambient air or the sea or ocean.

In some embodiments of the method, the air or gas stream is acid gas. In some embodiments, the air or gas stream is sour gas.

Also provided in the present disclosure is a method of treating acid gas, the method including contacting a stream of the acid gas with an aqueous composition containing an aqueous carbonate (or amine) solution and a regeneration catalyst to form a combined gas-liquid composition; heating the gas-liquid composition to about 60° C. to less than about 100° C. to free a gaseous stream containing CO₂, H₂S, or both from the gas-liquid composition; and collecting the gaseous stream containing the CO₂, H₂S, or both; where the regeneration catalyst contains an element from group 2 of the periodic table.

In some embodiments of the method, the regeneration catalyst contains magnesium. In some embodiments, the regeneration catalyst is magnesium carbonate or magnesium hydroxide. In some embodiments, the concentration of the regeneration catalyst in the aqueous composition is about 0.01 mg/L to about 400 mg/L.

### DESCRIPTION OF DRAWINGS

FIGS. 1A-1B depict the reactions involved in the acid gas regeneration process. FIG. 1A depicts the catalytic decarboxylation step and FIG. 1B depicts the catalytic dehydrosulfidation step.

FIG. 2 illustrates an exemplary energy efficient carbon dioxide capture process.

FIG. 3 illustrates an exemplary energy efficient acid gas treatment process.

FIG. 4 illustrates an exemplary energy efficient direct carbon dioxide capture process.

FIG. 5 is a graph showing decarboxylation at 55° C. with an exemplary catalyst and no catalyst.

### DETAILED DESCRIPTION

Provided in the present disclosure is a method of regenerating CO₂ and/or H₂S from acid gas using a catalyst containing an element from group 2 of the periodic table (alkaline earth metal). Also provided is a method for regenerating an acid gas absorbent using a catalyst containing an element from group 2 of the periodic table (alkaline earth metals). The methods of the present disclosure are efficient and cost-effective. In some embodiments, the methods reduce the energy required for the regeneration process of an acid gas absorbent as compared to known methods that do not use such a catalyst. In some embodiments, the methods reduce the energy required for the regeneration process of acid gas (CO₂ and/or H₂S) as compared to known methods that do not use such a catalyst. The methods of the present disclosure utilize a catalyst that allows for freeing and regenerating the acid gas at lower temperatures than the same process that does not utilize the catalyst. Thus, provided in the present disclosure is a method of regenerating acid gas at low temperatures, such as lower than about 120° C. In some embodiments, the acid gas is regenerated at temperatures from about 45° C. to less than about 100° C., such as about 45° C. to about 65° C., such as about 50° C. to about 55° C. or about 60° C. to about 65° C. In some embodiments, the regenerated acid gas is free of residual amines. In some embodiments, the regenerated acid gas is used for enhanced oil recovery (EOR) or for enriching the atmosphere of agricultural and/or aquacultural factories or greenhouses. In some embodiments, the regenerated acid gas is CO₂. In some embodiments, the regenerated acid gas is H₂S. The methods of the present disclosure also provide a simple and selective method of direct air carbon capture (DACC) that does not involve the use of dangerous materials or chemicals, such as amines.

The methods of the present disclosure provide a simple, efficient, and cost-effective way to regenerate acid gas, carbon dioxide (CO₂) and hydrogen sulfide (H₂S), from a metal carbonate and/or amine solution from an amine process or carbonate process. In some embodiments, the method is used with an amine process. In some embodiments, the method is used with a carbonate process. In some embodiments, the carbonate process is a “promoted” carbonate process in which a promoter is used to increase the kinetics of the carbonate process. In some embodiments, the promoters increase carboxylation. The promoter can be organic, inorganic, or enzymatic compounds that increase carboxylation. Suitable promoters include, but are not limited to, organic compounds such as amines and amino acids, inorganic compounds such as vanadate, borate, and arsenate, or enzymatic compounds such as carbonic anhydrase and mimicking metalloenzyme compounds. In some embodiments, the metal carbonate and/or amine solution is a potassium carbonate solution. In some embodiments, the metal carbonate and/or amine solution is a methyldiethanolamine (MDEA) solution. The methods of acid gas regeneration of the present disclosure use a catalyst containing an element from group 2 of the periodic table. In some embodiments, the catalyst contains magnesium or calcium. In some embodiments, the catalyst contains magnesium. In some embodiments, the catalyst is magnesium carbonate. In the methods of the present disclosure, the carbonate catalyst, such as magnesium carbonate, is carboxylated to form a bicarbonate, such as magnesium bicarbonate. Magnesium bicarbonate (Mg(HCO₃)₂) decarboxylates at a relatively low temperature (about 45° C. to about 55° C. or about 318 K to about 328 K) to give magnesium carbonate and CO₂, while other bicarbonates, such as sodium bicarbonate or potassium bicarbonate, decarboxylate at much higher temperatures (such as >120° C. or >393 K). In some embodiments, the catalyst is magnesium hydroxide. In the methods of the present disclosure, the hydroxide catalyst, such as magnesium hydroxide, is hydrosulfidated to form a hydrosulfide, such as magnesium hydrosulfide. Magnesium hydrosulfide (Mg(SH)₂) dehydrosulfidates with water to give magnesium hydroxide and H₂S at a relatively low temperature (about 60° C. to about 65° C. or about 333 K to about 338 K). Such a low regeneration temperature means that renewable or recovered heat can be used to free H₂S and CO₂ gas from an aqueous solution, thus using lower energy than the same process that does not use such a catalyst.

Conventional methods for capturing CO₂ (such as the amine process or the use of potassium carbonate) have higher regeneration temperatures. In the methods of the present disclosure, a regeneration catalyst containing an element from group 2 of the periodic table is used to free the acid gas at lower temperatures than required in such conventional methods. In some embodiments, temperatures as low as about 45° C. to about 65° C. are used.

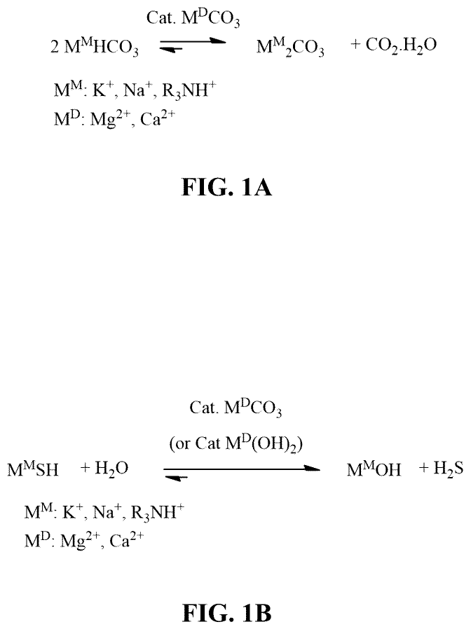

The methods of the present disclosure are an improved process for regenerating and capturing carbon dioxide and hydrogen sulfide from natural gas, such as natural acid gas. In some embodiments, the methods of the present disclosure improve upon the amine process by using less energy. The methods of the present disclosure employ the bicarbonate/carbonate cycle and are able to overcome the high energetic penalty of the regeneration step and prevent scaling due to hardness. The catalytic reactions of the regeneration step are shown in FIGS. 1A-1B.

FIG. 1A shows the catalytic decarboxylation step of the methods of the present disclosure. In some embodiments, the method involves contacting two equivalents of a sorbent M^{M}HCO₃ with a catalyst of the present disclosure, M^{D}CO₃, giving M^{M}₂CO₃, CO₂, and H₂O. FIG. 1B shows the catalytic dehydrosulfidation step of the methods of the present disclosure. In some embodiments, the method involves contacting one equivalent of a sorbent M^{M}SH and H₂O with a catalyst of the present disclosure, M^{D}CO₃ or M^{D}(OH)₂, resulting in one equivalent of M^{M}OH and H₂S.

In some embodiments, M^{M} is an alkali metal from group 1 of the periodic table (alkali metal). In some embodiments, M^{M} is selected from potassium and sodium. In some embodiments, M^{M} is potassium. In some embodiments, M^{M} is sodium. In some embodiments, M^{M} is an amine in an ammonium salt form (R₃NH⁺). In some embodiments, M^{M} is an amine that produces mainly bicarbonate ammonium salts when reacted with carbon dioxide. In some embodiments, the amine is a nitrogen-containing heteroaromatic amine. Examples of suitable nitrogen-containing heteroaromatic amines include those disclosed in U.S. Pat. No. 11,123,684. In some embodiments, the amine is a hindered amine. Examples of suitable hindered amines include those disclosed in U.S. Pat. No. 9,707,512. The bicarbonate of such sorbents decarboxylates at high temperatures (for example, higher than about 100° C. (373 K)), though they have a large loading capacity due to the high solubility of their bicarbonate species.

In some embodiments, M^{D} is an alkaline earth metal from group 2 of the periodic table (alkaline earth metal). In some embodiments, M^{D} is selected from magnesium and calcium. In some embodiments, M^{D} is magnesium. In some embodiments, M^{D} is calcium. Though the bicarbonates of these metals decarboxylate at low temperatures (for example, about 45° C. to about 55° C. or about 313 K to about 328 K), the carbonates and bicarbonates of these cations have relatively low solubilities, which can result in pipe carbonate scaling formation. However, it has surprisingly been found by the inventors of the present disclosure that introducing a cation exchange reaction using the metal M^{D} as a regeneration catalyst overcomes these disadvantages. The M^{D} cations, e.g., Mg or Ca cations, cannot be used as sorbent because they will quickly form scale. However, and without wishing to be bound by any particular theory, it is believed that these cations can be used as decarboxylation catalysts because the cation exchange reaction is possible. Additionally, the cations can be used in mass concentration (catalytic amount is less than or equal to about 10 ppm), well below their solubility values.

In the methods of the present disclosure, the regeneration catalyst is present in the absorbent solution containing carbonate or amine. In some embodiments, the absorbent solution is an aqueous solution. In some embodiments, the concentration of regeneration catalyst in the absorbent solution is about 0.01 mg/L to about 400 mg/L, such as about 0.01 mg/L to about 350 mg/L, about 0.01 mg/L to about 300 mg/L, about 0.01 mg/L to about 250 mg/L, about 0.01 mg/L to about 200 mg/L, about 0.01 mg/L to about 150 mg/L, about 0.01 mg/L to about 100 mg/L, about 0.01 mg/L to about 50 mg/L, about 0.01 mg/L to about 25 mg/L, about 0.01 mg/L to about 10 mg/L, about 0.01 mg/L to about 5 mg/L, about 0.01 mg/L to about 1 mg/L, about 1 mg/L to about 400 mg/L, about 1 mg/L to about 350 mg/L, about 1 mg/L to about 300 mg/L, about 1 mg/L to about 250 mg/L, about 1 mg/L to about 200 mg/L, about 1 mg/L to about 150 mg/L, about 1 mg/L to about 100 mg/L, about 1 mg/L to about 50 mg/L, about 1 mg/L to about 25 mg/L, about 1 mg/L to about 10 mg/L, about 1 mg/L to about 5 mg/L, about 5 mg/L to about 400 mg/L, about 5 mg/L to about 350 mg/L, about 5 mg/L to about 300 mg/L, about 5 mg/L to about 250 mg/L, about 5 mg/L to about 200 mg/L, about 5 mg/L to about 150 mg/L, about 5 mg/L to about 100 mg/L, about 5 mg/L to about 50 mg/L, about 5 mg/L to about 25 mg/L, about 5 mg/L to about 10 mg/L, about 10 mg/L to about 400 mg/L, about 10 mg/L to about 350 mg/L, about 10 mg/L to about 300 mg/L, about 10 mg/L to about 250 mg/L, about 10 mg/L to about 200 mg/L, about 10 mg/L to about 150 mg/L, about 10 mg/L to about 100 mg/L, about 10 mg/L to about 50 mg/L, about 10 mg/L to about 25 mg/L, about 25 mg/L to about 400 mg/L, about 25 mg/L to about 350 mg/L, about 25 mg/L to about 300 mg/L, about 25 mg/L to about 250 mg/L, about 25 mg/L to about 200 mg/L, about 25 mg/L to about 150 mg/L, about 25 mg/L to about 100 mg/L, about 25 mg/L to about 50 mg/L, about 50 mg/L to about 400 mg/L, about 50 mg/L to about 350 mg/L, about 50 mg/L to about 300 mg/L, about 50 mg/L to about 250 mg/L, about 50 mg/L to about 200 mg/L, about 50 mg/L to about 150 mg/L, about 50 mg/L to about 100 mg/L, about 100 mg/L to about 400 mg/L, about 100 mg/L to about 350 mg/L, about 100 mg/L to about 300 mg/L, about 100 mg/L to about 250 mg/L, about 100 mg/L to about 200 mg/L, about 100 mg/L to about 150 mg/L, about 150 mg/L to about 400 mg/L, about 150 mg/L to about 350 mg/L, about 150 mg/L to about 300 mg/L, about 150 mg/L to about 250 mg/L, about 150 mg/L to about 200 mg/L, about 200 mg/L to about 400 mg/L, about 200 mg/L to about 350 mg/L, about 200 mg/L to about 300 mg/L, about 200 mg/L to about 250 mg/L, about 250 mg/L to about 400 mg/L, about 250 mg/L to about 350 mg/L, about 250 mg/L to about 300 mg/L, about 300 mg/L to about 400 mg/L, about 300 mg/L to about 350 mg/L, about 350 mg/L to about 400 mg/L, or about 0.01 mg/L, about 0.05 mg/L, about 0.1 mg/L, about 0.5 mg/L, about 1 mg/L, about 5 mg/L, about 10 mg/L, about 25 mg/L, about 50 mg/L, about 100 mg/L, about 150 mg/L, about 200 mg/L, about 250 mg/L, about 300 mg/L, about 350 mg/L, or about 400 mg/L.

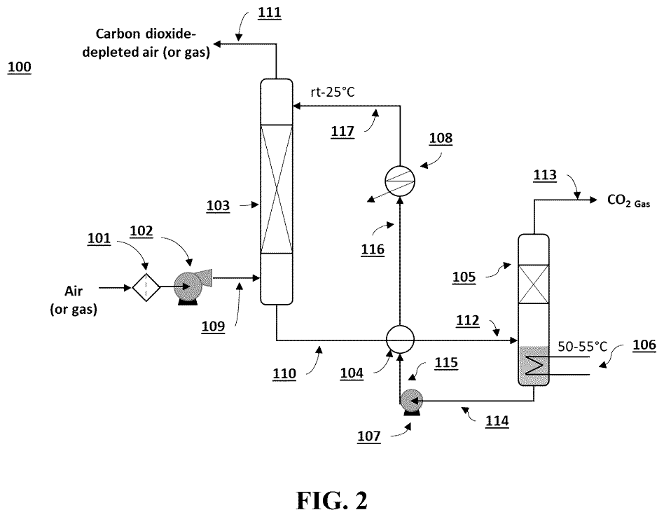

The reactions depicted in FIG. 1A and FIG. 1B can be used in methods of CO₂ capture and acid gas treatment. The methods include the use of a catalyst that contains a group 2 element from the periodic table. Thus, provided in the present disclosure are methods for capturing carbon dioxide (CO₂). The process (100) description is shown in FIG. 2. The air (or gas) stream (109) is passed through a filter (101) to remove solid particles (for example, dust) in suspension in the air (or gas) stream. Then, this stream (109) is injected at the bottom of a contactor (or absorber) (103). An aqueous carbonate (or amine) stream (117) that contains a regeneration catalyst is passed counter-current the gas stream (109) in the contactor (103). At the top of the contactor, a carbon dioxide-depleted air (or gas) stream exits the contactor (103). An aqueous bicarbonate stream (110) exits the bottom of the contactor (103) to enter an economizer (104) in order to recover some heat from the liquid stream (115). The hotter bicarbonate and/or hydrosulfide stream (112) enters the bottom of flash column (105). The aqueous solution at the bottom of the column is heated using a heat exchanger (106). The hot aqueous solution frees a CO₂ stream (113), which is collected at the top of the flash column (105). The aqueous stream (114) is sent to a pump (107). The aqueous stream (115) exiting the pump (107) is sent to the economizer (104) and then to a cooler (108) via (116). The liquid stream (117) exiting the cooler is sent to the top of the contactor (103).

The air (or gas) stream (109) can be any air or gas stream that contains carbon dioxide, hydrogen sulfide, or both. In some embodiments, the air or gas stream contains carbon dioxide. In some embodiments, the air or gas stream contains hydrogen sulfide. In some embodiments, the air or gas stream contains carbon dioxide and hydrogen sulfide. In some embodiments, the air or gas stream is natural gas. In some embodiments, the air or gas stream is acid gas.

The aqueous carbonate (or amine) stream (117) that contains a regeneration catalyst is passed counter-current the gas stream (109) in the contactor (103). In some embodiments, the regeneration catalyst is a catalyst of the present disclosure. In some embodiments, the regeneration catalyst comprises an element from group 2 of the periodic table. In some embodiments, the regeneration catalyst comprises magnesium or calcium. In some embodiments, the regeneration catalyst is magnesium carbonate. In some embodiments, the concentration of regeneration catalyst in the aqueous carbonate (or amine) stream is about 0.01 mg/L to about 400 mg/L.

The aqueous solution that enters the bottom of flash column (105) is a bicarbonate and/or hydrosulfide stream (112). In some embodiments, the flash column is selected from a demister, a packed column, and an agitated vessel. The aqueous solution is heated using a heat exchanger (106). In some embodiments, the solution is heated to about 45° C. to about 80° C., such as about 45 C, about 50° C., about 55° C., about 60° C., about 65° C., about 70° C., about 75° C., or about 80° C. In some embodiments, the aqueous stream (112) contains bicarbonate and the solution is heated to about 45° C. or higher. In some embodiments, the aqueous stream (112) contains hydrosulfide and the solution is heated to about 60° C. or higher. In some embodiments, the aqueous stream (112) contains bicarbonate and hydrosulfide and the solution is heated to about 60° C. or higher. In some embodiments, the heat source is recovered low heat from a different process, such as a low-pressure steam or hot water. In some embodiments, the low heat is renewable heat, such as heat from the sun. In some embodiments, the low heat is renewable heat from the sun, such as in a tropical climate.

The aqueous stream (115) exits the pump (107) and is sent to the economizer (104) and then to a cooler (108). In some embodiments, the cold source for the cooler is ambient air. In some embodiments, the cold source is ambient air in a continental climate. In some embodiments, the cold source is the sea or ocean. In some embodiments, the cold source is the sea or ocean in a tropical climate.

The liquid stream (117) that exits the cooler is sent to the top of the contactor (103). In some embodiments, the contactor is a falling-film column, a packed column, a bubble column, a spray tower, or a gas-liquid agitated vessel.

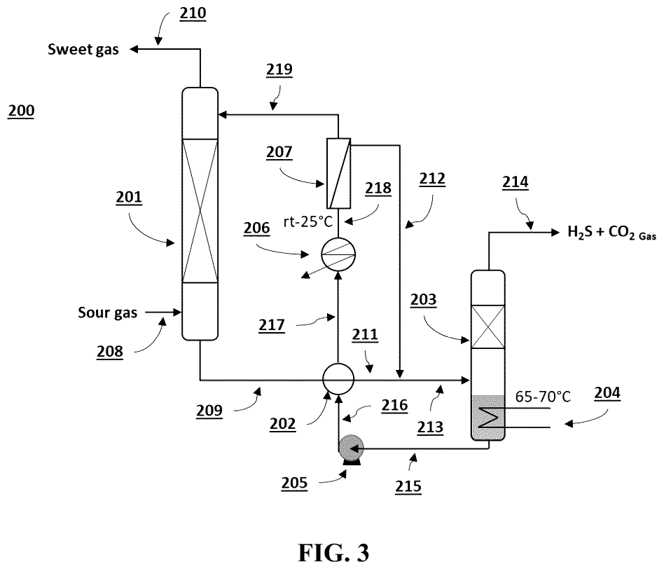

Also provided in the present disclosure are methods for treating acid gas. The methods include the use of a catalyst that contains a group 2 element from the periodic table. The process (200) description is shown in FIG. 3. The acid gas stream (208) is injected at the bottom of a contactor (or absorber) (201). The aqueous sorbent stream that does not contain a regeneration catalyst (219) is passed counter-current the gas stream (208) in the contactor (201). At the top of the contactor, a sweet gas stream (210) exits the contactor (201). An aqueous bicarbonate and hydrosulfide stream (209) exits the bottom of the contactor (201) to enter an economizer (202) in order to recover some heat from the liquid stream (216). The hotter bicarbonate and hydrosulfide stream (211) mixes with a smaller and cooler stream (212) loaded with the regeneration catalyst before entering the bottom of the flash column (203) via (213). The aqueous solution at the bottom of the column is heated by a heat exchanger (204). The hot aqueous solution frees an acid gas stream (214), which is collected at the top of the flash column (203). The aqueous stream (215) is sent to a pump (205). The aqueous stream (216) exiting the pump (205) is sent to the economizer (202) and then to a cooler (206) via (217). The liquid stream (218) exiting the cooler is sent to a filtration membrane (207). The permeate containing amine in water (219) is sent to the contactor (201). The retentate (212) containing the catalyst is mixed with acid gas-rich sorbent stream (211). The mixture (213) is sent to the flash column (203). Depending on the hydrosulfide ion concentration, the retentate can be sent directly to the flash column (203) to avoid potential scaling of magnesium hydrosulfide (Mg(SH)₂) or magnesium sulfide (MgS) in the pipe.

The acid gas stream (208) can be any gas stream that contains carbon dioxide, hydrogen sulfide, or both. In some embodiments, the acid gas stream contains carbon dioxide. In some embodiments, the acid gas stream contains hydrogen sulfide. In some embodiments, the acid gas stream contains carbon dioxide and hydrogen sulfide. In some embodiments, the acid gas stream is natural gas. In some embodiments, the acid gas stream has a temperature of about 25° C. to about 60° C.

The cooler stream (212) that enters the bottom of the flash column (203) contains the regeneration catalyst. In some embodiments, the flash column is selected from a demister, a packed column, and an agitated vessel. In some embodiments, the regeneration catalyst contains an element from group 2 of the periodic table (alkaline earth metal). In some embodiments, the element from group 2 of the periodic table is selected from beryllium, magnesium, calcium, strontium, barium, and radium. In some embodiments, the element from group 2 of the periodic table is magnesium. In some embodiments, the element from group 2 of the periodic table is calcium. In some embodiments, the regeneration catalyst is a carbonate. In some embodiments, the regeneration catalyst is magnesium carbonate. In some embodiments, the regeneration catalyst is a hydroxide. In some embodiments, the regeneration catalyst is magnesium hydroxide. In some embodiments, the acid gas stream contains hydrogen sulfide and the regeneration catalyst is a hydroxide. In some embodiments, the acid gas stream contains hydrogen sulfide and the regeneration catalyst is magnesium hydroxide. In some embodiments, the acid gas stream contains carbon dioxide and the regeneration catalyst is a carbonate. In some embodiments, the acid gas stream contains carbon dioxide and the regeneration catalyst is magnesium carbonate. In some embodiments, the acid gas stream contains carbon dioxide and hydrogen sulfide and the regeneration catalyst is a hydroxide. In some embodiments, the acid gas stream contains carbon dioxide and hydrogen sulfide and the regeneration catalyst is magnesium hydroxide. In some embodiments, the acid gas stream contains carbon dioxide and hydrogen sulfide and the regeneration catalyst is a carbonate. In some embodiments, the acid gas stream contains carbon dioxide and hydrogen sulfide and the regeneration catalyst is magnesium carbonate. In some embodiments, use of the regeneration catalyst of the present disclosure allows for freeing of the carbon dioxide, hydrogen sulfide, or both, at temperatures lower than those of the same process that does not use the regeneration catalyst.

The aqueous solution that enters the bottom of flash column (203) is heated using a heat exchanger (204). In some embodiments, the solution is heated to about 60° C. to less than about 100° C., such as about 60° C., about 65° C., about 70° C., about 75° C., about 80° C., about 85° C., about 90° C., about 95° C., about 96° C., about 97° C., about 98° C., or about 99° C. In some embodiments, the heat source is recovered low heat from a different process, such as a low-pressure steam or hot water. In some embodiments, the low heat is renewable heat, such as heat from the sun. In some embodiments, the low heat is renewable heat from the sun, such as in a tropical climate.

The aqueous stream (216) exits the pump (205) and is sent to the economizer (202) and then to a cooler (206). In some embodiments, the cold source for the cooler is ambient air. In some embodiments, the cold source is ambient air in a continental climate. In some embodiments, the cold source is the sea or ocean. In some embodiments, the cold source is the sea or ocean in a tropical climate.

The liquid stream (218) that exits the cooler is sent to a filtration membrane, such as a nanofiltration (NF) membrane. An exemplary NF membrane is NTR-729HF, sold by Nitto Denko (Teaneck, New Jersey).

The permeate containing amine in water (219) is sent to the contactor (201). In some embodiments, the contactor is a falling-film column, a packed column, a bubble column, a spray tower, or a gas-liquid agitated vessel.

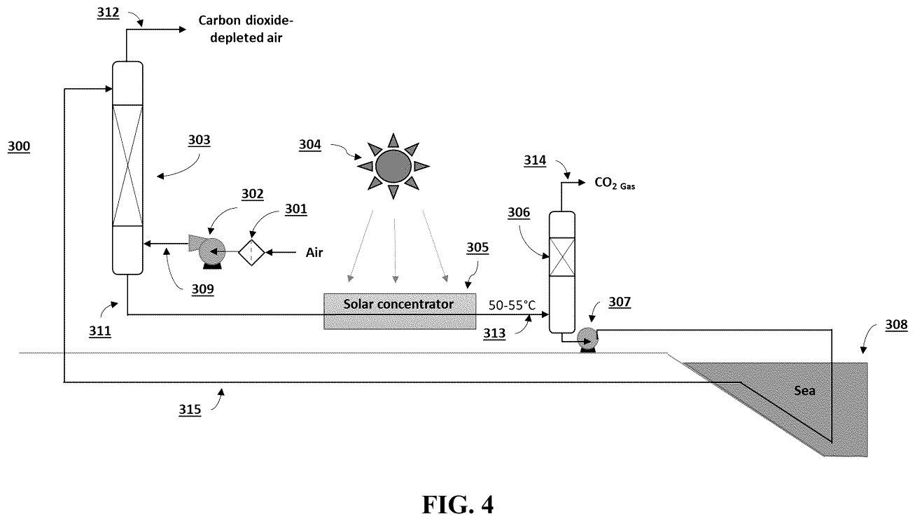

Also provided in the present disclosure are methods for direct CO₂ capture. The methods include the use of a catalyst that contains a group 2 element from the periodic table. The method is an energy efficient process for the direct capture of carbon dioxide. In some embodiments, the process involves the use of natural sources of energy, such as heat from the sun, cooling from the ocean or sea, or both. The process (300) description is shown in FIG. 4. The air (or gas) stream (309) is passed through a filter (301) to remove solid particles (for example, dust) in suspension in the air (or gas) stream. Then the stream (309) is injected at the bottom of a contactor (303). The cool aqueous sorbent stream that contains a regeneration catalyst (315) absorbs CO₂ from the air (or gas) stream (309) in the contactor (303). A carbon dioxide-depleted air stream exits (312) at the top of the contactor (303). An aqueous bicarbonate stream (311) is heated using solar concentrator (305) and sent to a flash column (306) via 313. The hot aqueous solution (313) frees a CO₂ stream (314), which is collected at the top of the flash column (306). The aqueous CO₂-lean stream (315) is sent via a pump (307) to a cold source (308) to cool. The liquid stream (315) is sent to the contactor (303).

The air (or gas) stream (309) can be any air or gas stream that contains carbon dioxide, hydrogen sulfide, or both. In some embodiments, the air or gas stream contains carbon dioxide. In some embodiments, the air or gas stream contains hydrogen sulfide. In some embodiments, the air or gas stream contains carbon dioxide and hydrogen sulfide. In some embodiments, the air or gas stream is natural gas. In some embodiments, the air or gas stream is acid gas.

The cool aqueous sorbent stream (315) that contains a regeneration catalyst absorbs CO₂ from the air (or gas) stream (309) in the contactor (303). In some embodiments, the regeneration catalyst is a catalyst of the present disclosure. In some embodiments, the regeneration catalyst comprises an element from group 2 of the periodic table. In some embodiments, the regeneration catalyst comprises magnesium or calcium. In some embodiments, the regeneration catalyst is magnesium carbonate. In some embodiments, the concentration of regeneration catalyst in the aqueous carbonate (or amine) stream is about 0.01 mg/L to about 400 mg/L.

The aqueous bicarbonate stream (311) is heated using solar concentrator (305) and sent to a flash column (306). In some embodiments, the flash column is selected from a demister, a packed column, and an agitated vessel. The aqueous solution is heated using a solar concentrator. In some embodiments, the solution is heated to about 45° C. to less than about 100° C., such as about 45° C., about 50° C., about 55° C., about 60° C., about 65° C., about 70° C., about 75° C., about 80° C., about 85° C., about 90° C., about 95° C., about 96° C., about 97° C., about 98° C., or about 99° C. In some embodiments, the low heat is renewable heat, such as heat from the sun. In some embodiments, the low heat is renewable heat from the sun, such as in a tropical climate.

The aqueous CO₂-lean stream (315) is sent to a cold source (308). The cold source can be any source that is capable of cooling the aqueous stream to the desired temperature. In some embodiments, the cold source is the ocean or sea.

The liquid stream (315) that exits the cold source is sent to the contactor (303). In some embodiments, the contactor is a falling-film column, a packed column, a bubble column, a spray tower, or a gas-liquid agitated vessel.

Thus, provided in the present disclosure are methods for removing carbon dioxide (CO₂) from an air or gas stream, where the method includes contacting an air or gas stream that contains CO₂ with a regeneration catalyst that includes an element from group 2 of the periodic table, heating the resulting composition to about 45° C. to less than about 100° C., such as about 50° C. to about 55° C., freeing a gaseous stream containing CO₂ from the composition, and collecting the CO₂. In some embodiments, the resulting composition is heated to about 50° C. to about 55° C. In some embodiments, the contacting of the air or gas stream with a regeneration catalyst is under absorber conditions. As used herein, “absorber conditions” refers to the temperature of the absorber and the presence of absence of the regeneration catalyst in the absorbent solution. In some embodiments, the regeneration catalyst is in the absorbent solution and the absorbers have a temperature below about 40° C. (see, for example, FIG. 2 and FIG. 4). In some embodiments, the regeneration catalyst is removed from the absorbent solution by a selective membrane and the absorber has a temperature between about 30° C. to about 80° C. (see, for example, FIG. 3) Also provided in the present disclosure are methods for removing hydrogen sulfide (H₂S) from a gas stream, where the method includes contacting a gas stream that contains H₂S with a regeneration catalyst that includes an element from group 2 of the periodic table, heating the resulting composition to about 60° C. to less than about 100° C., such as about 60° C. to about 65° C., freeing a gaseous stream containing H₂S from the composition, and collecting the H₂S. In some embodiments, the resulting composition is heated to about 60° C. to about 65° C. In some embodiments, the catalyst contains magnesium. In some embodiments, the air or gas is acid gas. In some embodiments, the heat source is a renewable or recovered heat source.

Also provided in the present disclosure is a method of treating acid gas, where the method includes contacting a stream of acid with a regeneration catalyst that includes an element from group 2 of the periodic table, heating the resulting composition to about 45° C. to less than 100° C., such as about 60° C. to about 65° C., freeing a gaseous stream containing H₂S, CO₂, or both from the composition, and collecting the H₂S, CO₂, or both. In some embodiments, the resulting composition is heated to about 60° C. to about 65° C.

The methods of the present disclosure are more cost-effective and energy efficient than similar methods that do not use the regeneration catalyst of the present disclosure, in part because of the lower regeneration temperatures required in the methods of the present disclosure and the opportunity to use renewable or recovered heat sources.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used herein, an “acid gas absorbent” is a base (pKa>7) which reacts with acid gas to give a salt, and therefore chemisorbs the acid gas in a solution.

As used herein, an “acid gas stream” is used broadly to refer to a gas stream which, when combined with water, forms an acidic solution. For example, in some embodiments the air or gas stream of the present disclosure includes one or more of carbon dioxide gas, hydrogen sulfide gas, mercaptans, and carbonyl sulfide.

As used herein, “sour gas” refers to any gaseous fluid containing hydrogen sulfide. In some embodiments, sour gas has greater than about 500 ppm hydrogen sulfide although any undesirable amount can also be considered a sour gas.

As used herein, “sweet gas” refers to any gaseous fluid having low hydrogen sulfide or substantially no hydrogen sulfide. In some embodiments, a sweet gas contains less than about 500 ppm, such as less than about 20 ppm hydrogen sulfide.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### EXAMPLES

### Example 1—Regeneration of CO₂ without Catalyst

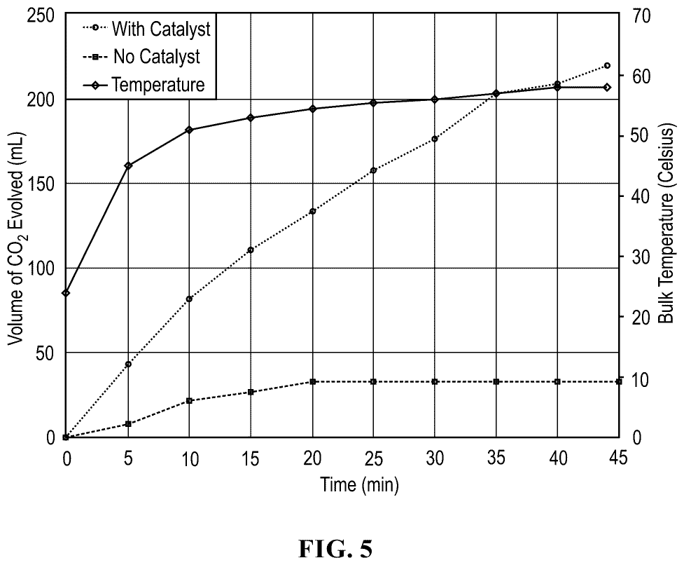

In a two-necked round bottom flask, 34.0725 g of sodium bicarbonate (0.4055 mol) was added to 100.0142 g of distilled water at room temperature. The aqueous suspension was stirred and heated at 55° C. The gas evolution was collected in an upside-down 250 mL graduated cylinder, initially filled with water and plunged in a 500 mL crystallizer. The volume displaced was recorded as a function of time. As shown in FIG. 5, a small volume of 33 mL was displaced, which was due to the increase of vapor in the flask plus a slight early decarboxylation of sodium bicarbonate. A plateau was reached after 20 minutes.

### Example 2—Regeneration of CO₂ with Catalyst

In a two-necked round bottom flask, 0.0388 g of magnesium carbonate (0.4601×10⁻³ mol) was added to 100.0748 g of distilled water at room temperature. After dissolution of the catalyst, 34.0646 g of sodium bicarbonate (0.4055 mol) was added to the aqueous solution at room temperature. Few early bubbles of carbon dioxide were observed. The aqueous suspension was stirred and heated at 55° C. The gas evolution was collected in an upside-down 250 mL graduated cylinder, initially filled with water and plunged in a 500 mL crystallizer. The volume displaced was recorded as a function of time. As shown in FIG. 5, a large volume of 220 mL was displaced, which was mainly due to the decarboxylation of bicarbonate (plus a negligible effect of the vapor increase in the flask). After 45 min, no plateau was reached compare to Example 1 (without catalyst).

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for removing carbon dioxide (CO₂) from an air or gas stream, comprising:
contacting the air or gas stream containing CO₂ with an aqueous composition comprising an aqueous carbonate (or amine) solution and a regeneration catalyst under absorber conditions to form an aqueous bicarbonate composition;
heating the aqueous bicarbonate composition to about 45° C. to less than about 100° C. to free a gaseous stream comprising CO₂ from the aqueous bicarbonate composition, resulting in an aqueous carbonate composition; and
collecting the gaseous stream comprising CO₂;
wherein the regeneration catalyst comprises an element from group 2 of the periodic table.

2. The method of claim 1, wherein the regeneration catalyst comprises magnesium or calcium.

3. The method of claim 1, wherein the regeneration catalyst is magnesium carbonate.

4. The method of claim 1, wherein the concentration of the regeneration catalyst in the aqueous composition is about 0.01 mg/L to about 400 mg/L.

5. The method of claim 1, wherein the heat source is a recovered or renewable heat source.

6. The method of claim 5, wherein the heat source is selected from low-pressure steam recovered from another process, hot water recovered from another process, or the sun.

7. The method of claim 1, further comprising recycling the aqueous carbonate composition subsequent to freeing the gaseous stream comprising CO₂ from the aqueous bicarbonate composition.

8. The method of claim 7, further comprising cooling the aqueous carbonate composition prior to recycling the aqueous carbonate composition and subsequent to freeing the gaseous stream comprising CO₂ from the aqueous bicarbonate composition.

9. The method of claim 8, wherein the cooling source is ambient air or the sea or ocean.

10. The method of claim 1, wherein the air or gas stream is acid gas.

11. A method for removing hydrogen sulfide (H₂S) from a gas stream, comprising:
contacting the gas stream containing H₂S with an aqueous composition comprising an aqueous carbonate (or amine) solution and a regeneration catalyst under conditions to form an aqueous hydrosulfide composition;
heating the aqueous hydrosulfide composition to about 60° C. to less than about 100° C. to free a gaseous stream comprising H₂S from the aqueous hydrosulfide composition, resulting in an aqueous hydroxide composition; and
collecting the gaseous stream comprising H₂S;
wherein the regeneration catalyst comprises an element from group 2 of the periodic table.

12. The method of claim 11, wherein the regeneration catalyst comprises magnesium or calcium.

13. The method of claim 11, wherein the regeneration catalyst is magnesium hydroxide.

14. The method of claim 11, wherein the concentration of the regeneration catalyst in the aqueous composition is about 0.01 mg/L to about 400 mg/L.

15. The method of claim 11, wherein the heat source is a recovered or renewable heat source.

16. The method of claim 15, wherein the heat source is selected from low-pressure steam recovered from another process, hot water recovered from another process, or the sun.

17. The method of claim 11, further comprising recycling the aqueous hydroxide composition subsequent to freeing the gaseous stream comprising H₂S from the aqueous hydrosulfide composition.

18. The method of claim 17, further comprising cooling the aqueous hydroxide composition prior to recycling the aqueous hydroxide composition and subsequent to freeing the gaseous stream comprising H₂S from the aqueous hydrosulfide composition.

19. The method of claim 18, wherein the cooling source is ambient air or the sea or ocean.

20. The method of claim 11, wherein the air or gas stream is acid gas.

21. The method of claim 11, wherein the air or gas stream is sour gas.

22. A method of treating acid gas, comprising:
contacting a stream of the acid gas with an aqueous composition comprising an aqueous carbonate (or amine) solution and a regeneration catalyst to form a combined gas-liquid composition;
heating the gas-liquid composition to about 60° C. to less than about 100° C. to free a gaseous stream comprising CO₂, H₂S, or both from the gas-liquid composition; and
collecting the gaseous stream comprising the CO₂, H₂S, or both;
wherein the regeneration catalyst comprises an element from group 2 of the periodic table.

23. The method of claim 22, wherein the regeneration catalyst comprises magnesium.

24. The method of claim 23, wherein the regeneration catalyst is magnesium carbonate or magnesium hydroxide.

25. The method of claim 22, wherein the concentration of the regeneration catalyst in the aqueous composition is about 0.01 mg/L to about 400 mg/L.
